(19) United States
(12) Patent Application Publication
(10) Pub. No.: US 2006/0188713 A1
(43) Pub. Date: Aug. 24, 2006

(54) Substrate-less double face adhesive tape

(76) Inventor: Cheng-Chuan Ko, Taoyuan Hsien (TW)

Correspondence Address: Cheng-Chuan Ko, 235 Chung - Ho, Box 8-24, Taipei, TW

(21) Appl. No.: 11/342,037

(22) Filed: Jan. 30, 2006

(30) Foreign Application Priority Data
Feb. 22, 2005 (TW) 094202767

(51) Int. Cl. B32B 7/12; B32B 15/04

(52) U.S. Cl. 428/354; 428/343

(57) ABSTRACT

A substrate-less double face adhesive tape comprises a sticky layer set having a first sticky layer, a second sticky layer and a third sticky layer; and the adhesions of the first sticky layer and third sticky layer being stronger than that of the second sticky layer; a first separable paper adhered upon an upper surface of the first sticky layer; and a second separable paper adhered upon a lower surface of the third sticky layer. The first sticky layer and third sticky layer are made from material selected from water acrylic glue, PU resin, and PU-acrylic glue and the second sticky layer is made of lower adhesion water-solvable glue.

### FIELD OF THE INVENTION

The present invention relates to a substrate-less double face adhesive tape, wherein the tape of the present invention can suffer from a great tearing force as the first separable paper or second separable paper is torn. Thus, when the first separable paper or second separable paper is torn, the sticky layer can be retained without being destroyed.

### BACKGROUND OF THE INVENTION

Referring to FIGS. 1 and 2, the prior art double face adhesive tape is illustrated. In the prior art, art, a glue layer 12 is adhered between two separable papers 10, 11. FIG. 3 shows the assembled view of the prior art double face adhesive tape. No substrate is used in this prior art.

The prior art substrate-less double face adhesive tape has high extension and high adhesion. Thereby it is difficult to break the tape and thus the length of a torn separable paper cannot be precisely controlled.

Referring to FIG. 4, when one surface 121 of the glue layer 12 is adhered to an object (not shown) and is fixed thereto, if it is desired to tear another separable paper. A small part of glue 122 will be adhered to the torn separable paper. Thereby the surface of the glue layer 12 will be destroyed so as to affect the adhesion of other object.

Furthermore, the prior art double face adhesive tape cannot be reused so as to induce the problem in environment protection.

### SUMMARY OF THE INVENTION

Accordingly, the primary object of the present invention is to provide a substrate-less double face adhesive tape, wherein the tape of the present invention can suffer from a great tearing force as the first separable paper or second separable paper is torn. Thus, when the first separable paper or second separable paper is torn, the sticky layer can be retained without destroy. Moreover the first sticky layer, second sticky layer and third sticky layer are made of materials solvable in alkaline water so that the double face adhesive tape of the present invention can be reused.

To achieve above objects, the present invention provides a substrate-less double face adhesive tape which comprises a sticky layer set having a first sticky layer, a second sticky layer and a third sticky layer; and the adhesions of the first sticky layer and third sticky layer being stronger than that of the second sticky layer; a first separable paper adhered upon an upper surface of the first sticky layer; and a second separable paper adhered upon a lower surface of the third sticky layer. The first sticky layer and third sticky layer are made from material selected from water acrylic glue, PU resin, and PU-acrylic glue and the second sticky layer is made of lower adhesion water-solvable glue.

The various objects and advantages of the present invention will be more readily understood from the following detailed description when read in conjunction with the appended drawing.

### BRIEF DESCRIPTION OF THE DRAWINGS

FIG. 1 is a perspective view of a prior art double face adhesive tape.

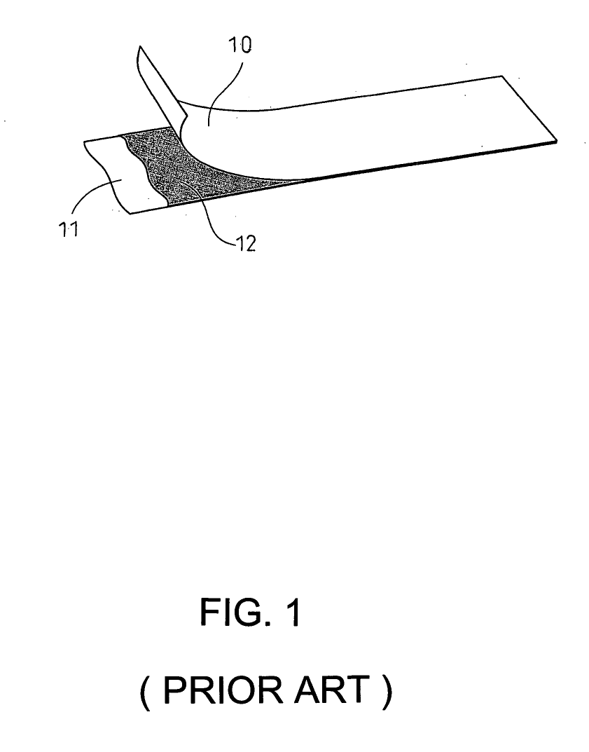

FIG. 2 is a partial cross sectional view of the tape in FIG. 1.

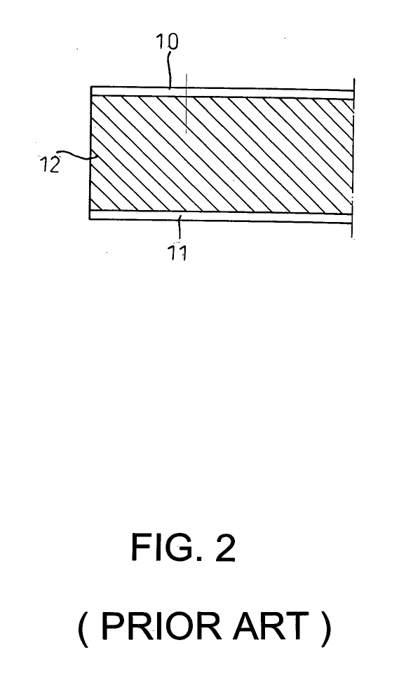

FIG. 3 shows an assembly view of the prior art tape.

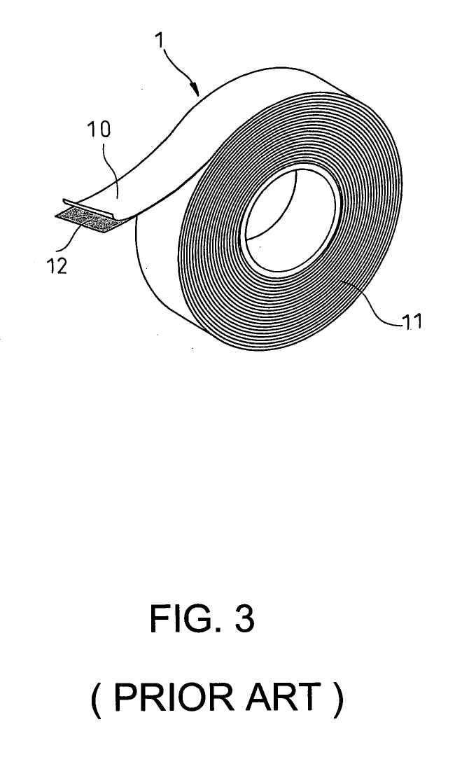

FIG. 4 shows the use of the prior art double face adhesive tape.

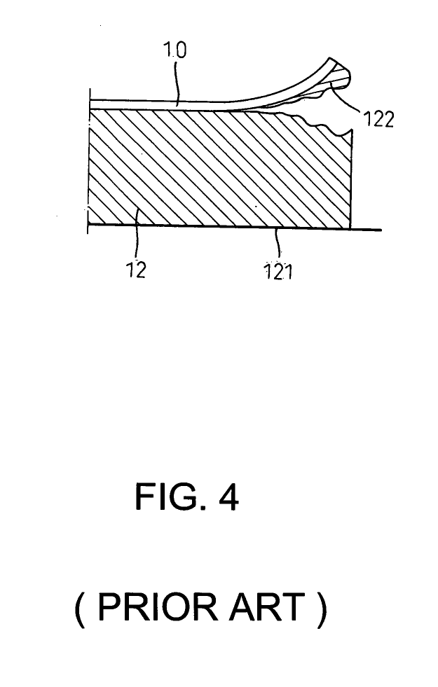

FIG. 5 shows the schematic view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

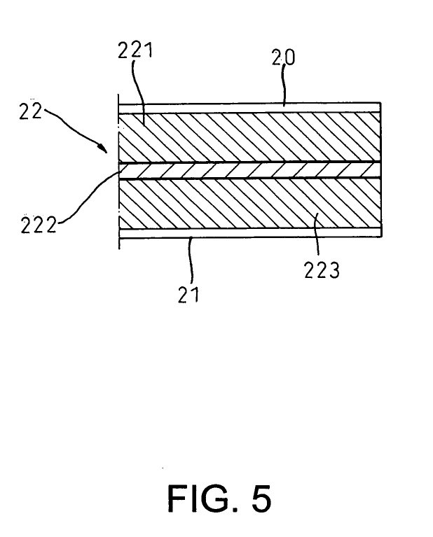

Referring to FIG. 5, the substrate-less double face adhesive tape of the present invention is illustrated. The present invention has the following elements.

A sticky layer set 22 has a first sticky layer 221, a second sticky layer 222 and a third sticky layer 223. The adhesions of the first sticky layer 221 and third sticky layer 223 are stronger than that of the second sticky layer 222.

A first separable paper 20 is adhered upon an upper surface of the first sticky layer 221.

A second separable paper 21 is adhered upon a lower surface of the third sticky layer 223.

In above arrangement, since the second sticky layer 222 has lower adhesion, the tape of the present invention can suffer from a great tearing force as the first separable paper 20 or second separable paper 21 is torn. Thus, when the first separable paper 20 or second separable paper 21 is torn, the sticky layer can be retained without destroy.

Preferable, the first sticky layer 221 and third sticky layer 223 are made of materials which is solvable alkaline water, such as water solvable acrylic glue, PU resin, or PU-acrylic glue and the second sticky layer 222 is preferably made of lower adhesion water-solvable glue. Thereby the present invention can be reused.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A substrate-less double face adhesive tape comprising:
a sticky layer set having a first sticky layer, a second sticky layer and a third sticky layer; and the adhesions of the first sticky layer and third sticky layer being stronger than that of the second sticky layer;
a first separable paper adhered upon an upper surface of the first sticky layer; and
a second separable paper adhered upon a lower surface of the third sticky layer.

2. The substrate-less double face adhesive tape as claimed in claim 1, wherein the first sticky layer, second sticky layer and third sticky layer are made of materials solvable in alkaline water.

3. The substrate-less double face adhesive tape as claimed in claim 1, wherein the first sticky layer and third sticky layer are made from materials selected from water acrylic glue, PU resin, and PU-acrylic glue and the second sticky layer is made of lower adhesion water-solvable glue.
